(19) United States
(12) Patent Application Publication
(10) Pub. No.: US 2006/0096073 A1
(43) Pub. Date: May 11, 2006

(54) Method to make elastic shirting fabric comprising spandex and hard yarn

(75) Inventors: Federica Maria Roberta Stoppa, Genthod (CH); Graham H. Laycock, Grangeford (SG); Tianyi Liao, Wilmington, DE (US); Raymond S.P. Leung, Shatin (CN)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA NORTH AMERICA S.A R.L., Wilmington, DE (US)

(21) Appl. No.: 11/268,112

(22) Filed: Nov. 7, 2005

Related U.S. Application Data
(63) Continuation-in-part of application No. 11/056,067, filed on Feb. 11, 2005.
(60) Provisional application No. 60/626,698, filed on Nov. 10, 2004.

(51) Int. Cl. D01D 5/34; D06C 15/00; B65H 71/00; D03D 15/00; C08G 18/08

(52) U.S. Cl. 28/166; 524/591; 264/172.15; 442/190; 28/165

(57) ABSTRACT

Methods for making stretch shirting fabric having fabric weight less than 175 g/m² and fabric stretch between 15% to 45% in the weft direction are disclosed. A corespun composite elastomeric yarn is produced either (a) by low draft (2.7× or below) core-spinning of the elastomeric yarn, or (b) by pretreating the corespun composite yarn in steam or heated water at temperatures of at least 110° C. to reduce yarn power before dyeing or weaving. The shirting fabric with such corespun composite elastomeric yarn in the weft meets end-use specifications without heat-setting.

### CONTINUITY DATA

This invention claims priority to Provisional Application No. 60/626,698 filed Nov. 10, 2004, now pending.

### FIELD OF THE INVENTION

This invention relates to methods for making corespun composite elastic yarns and stretch woven shirting fabrics from such yarns.

### BACKGROUND OF THE INVENTION

Stretch woven fabrics have been produced for nearly 30 years. Those working in the textile industry, such as yarn spinners, weavers, dyers/finishers, cutters and designers, understand that consumers desire fabrics and garments made with quality standards. However, lightweight stretch woven shirting fabrics (weighing less than 175 g/m²) generally are more difficult to produce since normal elastane fibers such as spandex have too much stretch power, and thus too tightly contract, resulting in fabrics that are too tight and too heavy. The jammed fabric structure results in shirting fabrics with higher shrinkage, a harsher, non-cottony fabric hand, and thermal discomfort during wear. Heat-setting may be a necessary step in the process to making lightweight (less than 175 g/m²) spandex stretch shirting fabrics with high comfort.

Most stretch woven fabrics are made with elastomeric yarns in the direction in which the stretch will exist. For example, elastomeric yarns are commonly used as the filling yarn in order to make weft stretch fabrics. For stretch woven shirting fabric, most of the elastomeric yarns are used in combination with relatively inelastic fibers, such as polyester, cotton, nylon, rayon or wool. These relatively inelastic fibers sometimes are called “hard” fibers.

Elastomeric fibers are commonly used to provide stretch and elastic recovery in woven fabrics and garments. “Elastomeric fibers” are either a continuous filament (optionally a coalesced multifilament) or a plurality of filaments, free of diluents, which have a break elongation in excess of 100%, independent of any crimp. An elastomeric fiber when (1) stretched to twice its length; (2) held for one minute; and (3) released, retracts to less than 1.5 times its original length within one minute of being released. As used in this application, “elastomeric fibers” should be interpreted to mean at least one elastomeric fiber or filament. Such elastomeric fibers include, but are not limited to, rubber filament, biconstituent filament and elastoester, lastol, and spandex.

“Spandex” is a manufactured filament in which the filament-forming substance is a long chain synthetic polymer comprised of at least 85% by weight of segmented polyurethane.

“Elastoester” is a manufactured filament in which the fiber forming substance is a long chain synthetic polymer composed of at least 50% by weight of aliphatic polyether and at least 35% by weight of polyester.

“Biconstituent filament” is a continuous filament comprising at least two polymers adhered to each other along the length of the filament, each polymer being in a different generic class, for example, an elastomeric polyetheramide core and a polyamide sheath with lobes or wings.

“Lastol” is a fiber of cross-linked synthetic polymer, with low but significant crystallinity, composed of at least 95% by weight of ethylene and at least one other olefin unit. This fiber is elastic and substantially heat resistant.

A “covered” elastomeric fiber is one surrounded by, twisted with, or intermingled with hard yarn. The covered yarn that comprises elastomeric fibers and hard yarns is also termed a “composite yarn” in this application. The hard-yarn covering serves to protect the elastomeric fibers from abrasion during weaving processes. Such abrasion can result in breaks in the elastomeric fiber with consequential process interruptions and undesired fabric non-uniformities. Further, the covering helps to stabilize the elastomeric fiber elastic behavior, so that the composite yarn elongation can be more uniformly controlled during weaving processes than would be possible with bare elastomeric fibers.

There are multiple types of composite yarns, including: (a) single wrapping of the elastomer fibers with a hard yarn; (b) double wrapping of the elastomer fibers with a hard yarn; (c) continuously covering (i.e., core spinning) an elastomer fiber with staple fibers, followed by twisting during winding; (d) intermingling and entangling elastomer and hard yarns with an air jet; and (e) twisting an elastomer fibers and hard yarns together. The most widely used composite yarn is a cotton/spandex corespun yarn. A “corespun yarn” consists of a separable core surrounded by a spun fiber sheath. Elastomeric corespun yarns are produced by introducing a spandex filament to the front drafting roller of a spinning frame where it is covered by staple fibers.

A representative core-spinning apparatus 40 is shown in FIG. 1. During core-spin processing, an elastomeric fiber, such as spandex, is combined with a hard fiber to form a composite corespun yarn. The spandex from tube 48 is unwound in the direction of arrow 50 by the action of positively-driven rollers 46. The rollers 46 serve as a cradle for the tube 48 and deliver the spandex filament or yarn 52 at a pre-determined speed.

The hard fiber or yarn 44 is unwound from tube 54 to meet the spandex filament 52 at the set of front rollers 42. The combined spandex filament 52 and hard fiber 44 are core-spun together at spinning device 56.

The spandex filament 52 is stretched (drafted) before it enters the front rollers 42. The spandex is stretched through the speed difference between feed rollers 46 and front rollers 42. The delivery speed of the front rollers 42 is greater than the speed of the feed rollers 46. Adjusting the speed of the feed rollers 42 gives the desired draft, which is known as the machine draft. Normally, the machine draft for corespun elastomeric composite yarns is from 3.0× to 3.8×. This corresponds to a spandex elongation of 200% to 280%, or more. The stretching of the spandex imparts elasticity to the final corespun yarn because the spandex core will retract when stress is removed, thus compacting and bulking the spun yarn cover. The resulting composite yarn can then be extended to the point where the non-elastic cover yarn is stretched to its limit.

Referring to FIG. 2, a representative method for making a core-spun elastomeric yarn and weaving that yarn to form a shirting fabric is disclosed. The elastomeric fiber and hard yarn, denoted as cotton in FIG. 2, are combined by core-spinning such as by the apparatus of FIG. 1, to form a composite corespun yarn 10. In the example processing method set out in FIG. 2, this composite corespun yarn is twist set 12 (i.e., treated with steam at temperatures of about 70° C. to about 80° C., sometimes up to 110° C.), wound 14, scoured, and/or bleached and dyed 16, rewound 18, woven into a shirting fabric 20, singed 21, de-sized 22, scoured, and/or bleached and dyed 24 and heat set at temperatures of 190° C. or greater 26, and sanforized 28.

Heat-setting 26 “sets” spandex in an elongated form. This is also known as re-deniering, wherein a spandex of higher denier is drafted, or stretched, to a lower denier, and then heated to a sufficiently high temperature, for a sufficient time, to stabilize the spandex at the lower denier. Heat-setting therefore means that the spandex permanently changes at a molecular level so that recovery tension in the stretched spandex is mostly relieved and the spandex becomes stable at a new and lower denier. Heat-setting temperatures for spandex are generally in the range of 175° C. to 200° C. Heat-setting conditions for conventional spandex are about 45 seconds or more at about 190° C.

Typically, stretch woven shirting fabrics are made with composite yarns that incorporate spandex having from 30 to 40 denier. The spandex can be stretched to about 3.0× to about 4.0× machine draft during the yarn covering or core-spinning process (step 10 in FIG. 2). The composite yarn is woven to form a fabric. If the resulting fabric is not heatset (step 26 in FIG. 2), these woven fabrics can have high stretch, high fabric recovery, and a synthetic fabric hand. Typically, stretch woven fabrics, which are made with composite yarns of from 30 to 40 denier spandex drafted to about 3.5× to 3.8× machine draft, contract too much after the fabric finishing processes, creating a heavy fabric with a poor hand.

To improve the fabric hand and reduce the fabric recovery power of stretch woven shirting fabrics, the heat-setting step (step 26 in FIG. 2) usually is required during fabric finishing. For heat-setting, the fabric is applied to a tenter frame and heated in an oven. The tenter frame holds the fabric on the edges by pins, and stretches it in both the length and width directions while in the oven in order to heat set the elastomeric fiber or yarn and return the fabric to desired dimensions and basis weight.

In conventional fabrics, if heat-setting 26 is not used to “set” the spandex, the fabric may have high shrinkage, excessive fabric weight, and excessive elongation, which may result in a negative experience for the consumer. Excessive shrinkage during the fabric finishing process may result in crease marks on the fabric surface during processing and household washing. Said creases may be very difficult to remove by ironing.

There is a need to produce lightweight, stretch woven shirting fabrics with a cottony hand, which are breathable, easy to care for, do not require fabric heat-setting, and are made by a simplified manufacturing process.

### SUMMARY OF THE INVENTION

The invention comprises methods for making stretch shirting fabric from composite corespun yarns without heat-setting the fabric in further processing. The invention further comprises stretch shirting fabrics and garments made from such fabrics.

According to a first embodiment of the method, an elastomeric fiber and a hard fiber are corespun to form a composite corespun elastomeric yarn, wherein the elastomeric fiber is drafted to no more than 2.7× of its original length during corespin covering. The elastomeric fiber may be bare spandex yarn from 11 to 44 dtex, and the hard fiber may be a hard yarn with a yarn count from 10 to 80 Ne. One suitable hard yarn is cotton.

According to a second embodiment of the method, an elastomeric fiber and a hard fiber are corespun to form a composite corespun elastomeric yarn, using customary drafting of 3.0× or more. After the corespun composite yarn is formed, it is pre-treated with hot water or steam at a temperature of at least 110° C. before dyeing or weaving. The pretreatment with steam may be in an autoclave at a temperature of from 110° C. to 130° C. for 6 to 60 minutes. The pretreatment with hot water may be in a yarn package dyer at a temperature of from 110° C. to 132° C. for 5 to 30 minutes. For this alternate embodiment, the elastomeric fiber used to form the composite corespun yarn may be bare spandex yarn from 22 to 156 dtex, and the hard fiber may be a hard yarn with a yarn count from 10 to 80 Ne. One suitable hard yarn is cotton.

A shirt fabric is woven using the composite corespun elastomeric yarn produced by one of these alternate methods. The composite corespun elastomeric yarn is used in at least the weft direction. Any weave pattern may be used, including: plain, 2/1 twill, 3/1 twill, oxford, poplin, dobby, sateen, and satin. Further processing of the fabric is carried out without heat-setting the fabric. Further processing may include cleaning, bleaching, dyeing, drying, compacting, sanforizing, singeing, de-sizing, mercerizing, and any combination of such steps.

One exemplary shirt fabric produced by the inventive method has a weight of 175 g/m² or less, and after washing has a shrinkage of 10% or less. Such fabric may have a Fabric Cover Factor between about 45% to about 70% in the warp direction and from about 30% to about 50% in the weft direction. Such fabric may have elongation in the weft direction from about 15% to about 45%. Such fabric may contain from 1% to 5% by weight, based on the total fabric weight per square meter of spandex as the elastomeric fiber in the composite corespun yarn. The stretch shirting fabric produced may be formed into a garment.

### BRIEF DESCRIPTION OF THE FIGURES

The detailed description will refer to the following drawings, wherein like numerals refer to like elements and wherein:

FIG. 1 is a schematic description of a core-spinning draft apparatus;

FIG. 2 is a block diagram of a method for forming a woven shirting fabric according to background art existing methods;

FIG. 3 is a block diagram of a method for forming a stretch woven shirting fabric according to a first embodiment of this invention;

FIG. 4 is a block diagram of a method for forming a stretch woven shirting fabric according to a second embodiment of this invention; and

FIG. 5 is a block diagram of a method for forming a stretch woven shirting fabric according to a third embodiment of this invention.

### DETAILED DESCRIPTION OF THE INVENTION

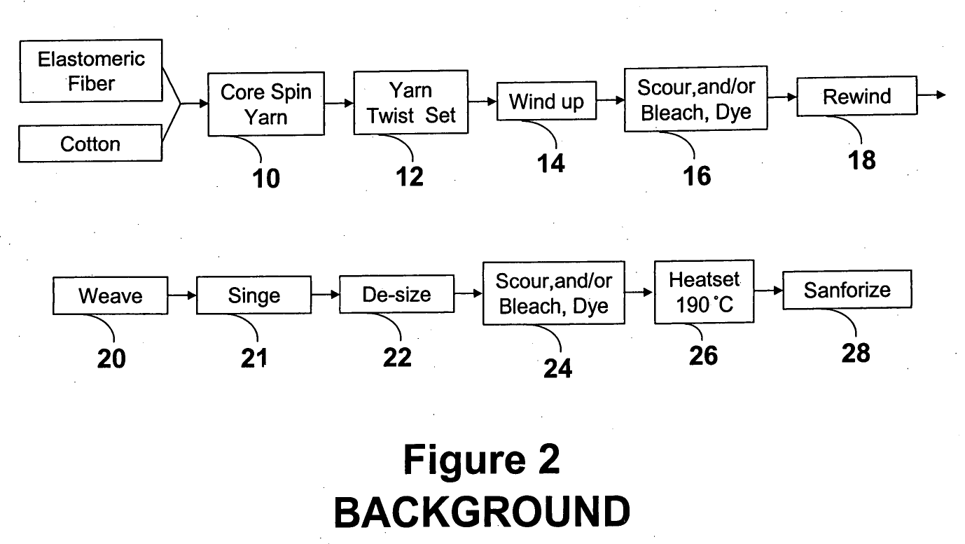

In one embodiment of the method of this invention, the heat-setting and yarn-twist set steps commonly used in background art shirting fabric forming methods (such as illustrated in FIG. 2) can be eliminated by using spandex yarns with a lower denier and lower draft to make the core-spun covered yarn. We found that when the total spandex draft, as measured in the composite yarn, can be between 1.5× and 2.7×, a more open fabric can be created that has improved fabric quality, including a cottony hand and good air permeability. Flat, stable fabrics for weights below 175 g/m² can be formed without heat-setting. In addition, fabric processing improvements may include ease of yarn package dyeing.

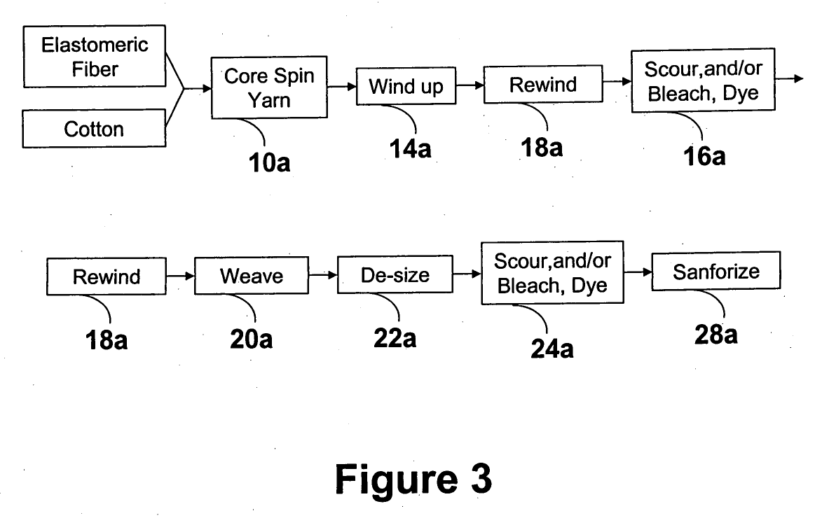

FIG. 3 illustrates this first embodiment of a method for making a stretch shirting fabric. Like reference numerals indicate like steps in FIGS. 2 and 3, however, the reference numerals include also an “a” designation in FIG. 3 to emphasize that the core-spinning is carried out differently, and thereafter a corespun yarn with different properties is processed in this first embodiment. Referring to FIG. 3, an elastomeric fiber and a hard fiber, denoted as cotton in FIG. 3, are combined by a core-spinning process to form a core spun yarn 10a.

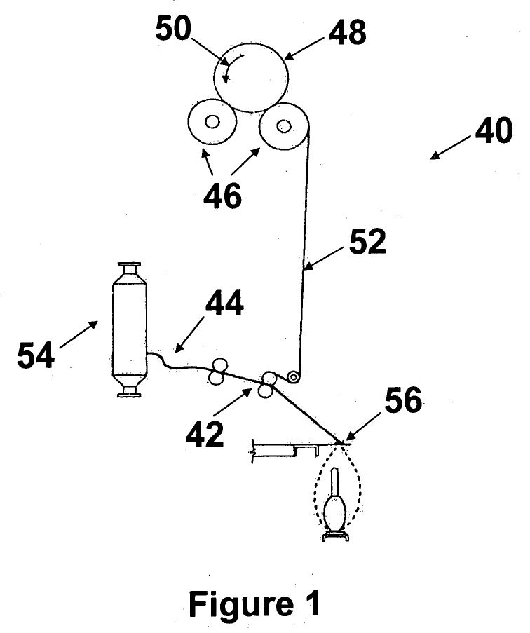

The elastomeric fiber, which may be spandex, is drafted only to 1.5× to 2.7× of its original length during the core-spinning process. This is a lower range than was used in background art core-spinning for shirting fabrics. The draft value range of 1.5× to 2.7× is the total draft of the spandex, which includes any drafting or drawing of the spandex that is included in the supply package of as-spun yarn. The value of residual draft from spinning is termed package relaxation, “PR”, and it typically ranges from 0.05 to 0.15 for the spandex used in composite yarn for woven fabrics. The total draft of the spandex in the composite yarn is therefore MD*(1+PR), where “MD” is the composite machine draft. Referring to FIG. 1 as illustrative, the composite machine draft is calculated as the ratio of front roller 42 speed to feed roller 46 speed.

Because of its stress-strain properties, spandex yarn drafts more as the tension applied to the spandex increases; conversely, the more that the spandex is drafted, the higher the tension in the yarn. If the total spandex draft in the composite yarn is higher than 2.7×, the yarns can have high power which can result in a jammed or tight fabric weave structure. Conversely, if the total spandex draft in the composite yarn is lower than 1.5×, the woven fabric may be unable to generate enough stretch to meet requirements for comfort.

In FIG. 3, the corespun elastomeric composite yarn is then wound up 14a, rewound 18a, scoured, and/or bleached and dyed 16a, and rewound 18a in preparation for weaving 20a. Different from the typical yarn treating steps of the method set out in FIG. 2, the corespun elastomeric composite yarn in the method of the invention is not twist set.

The treated corespun yarn is then woven to form a shirting fabric 20a. The corespun elastomeric composite yarn preferably is used as the weft in the weave for a shirting fabric. The corespun elastomeric composite yarn optionally may be used in the warp direction, although more frequently a nonelastomeric yarn will be used in the warp. Following weaving, the shirting fabric formed has sufficient stretch and a cottony hand without the need for heat-setting. The fabric maintains shrinkage of less than about 10% even without heatset. Different from the typical fabric treating steps of the method set out in FIG. 2, the stretch woven shirting fabric in the method of the invention is not heat set. The fabric otherwise may be post-processed as is customary in the industry, such as, for example shown in FIG. 3, de-sizing 22a, scouring, and/or bleaching and dyeing 24a, and sanforizing 28a.

Representative hard yarns include yarns made from natural and synthetic fibers. Natural fibers may be cotton, silk, or wool. Synthetic fibers may be nylon, polyester, or blends of nylon or polyester with natural fibers.

One exemplary corespun composite yarn for stretch woven shirting fabrics includes spandex as the elastomeric fiber and cotton as the hard fiber or yarn covering the spandex. The spandex may have 17 to 33 dtex, for example 22 to 33 dtex. For this composite yarn, the spandex draft is kept at about 2.7× or less. When the hard fiber or yarn is cotton, the hard yarn count, Ne, may be about 20 to about 80, for example from about 30 to about 60.

Commercially useful, elastic, shirting fabrics containing composite yarns of spandex and cotton can be made without heat-setting where the spandex draft is kept at about 2.7× or less. The content of spandex in the representative fabric, on a % weight basis, is from about 1.5% to about 5%, for example from about 2% to about 4%. For this fabric, the Fabric Cover Factor, which characterizes the openness of the shirt structure, is between about 45% and about 70%, and is typically 55% in the warp direction and between about 30% and about 50%, and is typically 40% in the weft direction. The fabric has an elongation in the weft direction of about 15% to about 45%, for example from about 20% to about 35%.

By eliminating the high-temperature heat-setting step 26 in the method, the new method may reduce heat damage to certain fibers (i.e., cotton) and thus may improve the hand or feel of the finished fabric. As a further benefit, heat sensitive hard yarns can be used to make stretch shirting fabrics in the new method, thus increasing the possibilities for different and improved products. In addition, eliminating process steps previously required shortens manufacturing time and improves productivity.

For many end uses, composite yarns containing spandex need to be dyed before weaving. Package yarn dyeing is the simplest and most economical method for processing composite yarns. For composite yarns comprised of cotton and elastomeric fiber(s), yarn package dye processing can be problematic. Specifically, the elastomeric core yarn will retract at the hot water temperatures used in package dyeing. In addition, the composite yarn on the package will compress and become very tight, thereby impeding the flow of dyestuffs into the interior of the yarn package. This often can result in yarn with different color shades and stretch levels, depending on the yarn's diametral position within the dyed package. Small packages are sometimes used for dyeing composite yarns to reduce this problem. However, small-package dyeing is relatively expensive because of extra packaging and handling requirements.

We found that a spandex/cotton corespun composite yarn made with lower spandex draft of the first embodiment of the invention performs better in yarn dyeing processes. The yarn does not have the excessive retractive power on the package that otherwise would create high package densities that lead to uneven dyeing. The method of the invention thus enables cone-dyeing of composite elastic corespun yarn without the need for special cone design and special handling.

We also found that these new stretch woven shirting fabrics can have a very good cottony hand. They have a gentle and natural touch and a better drape. Traditional stretch woven shirting fabrics are usually too stretchy and feel too synthetic.

Another benefit of the new stretch woven shirting fabric is an increased air permeability. Due to a lower contractive force of the new elastic composite yarn, the finished stretch woven fabrics keep a more open structure than is typically found in traditional stretch woven shirting fabrics. This feature may allow the fabrics to have higher air permeability and feel more breathable. Persons wearing garments formed from the shirting fabric experience greater comfort because of the higher air permeability.

In a second embodiment of the invention, the heat-setting and yarn-twist set steps commonly used in background art shirting fabric forming methods (such as illustrated in FIG. 2) can be eliminated by pre-treating the corespun composite yarn with high temperature steam prior to weaving.

Stretch composite yarns with spandex often undergo steaming in an autoclave prior to warping or weaving. Typically, the purpose of this process is to reduce the liveliness of the composite yarn. It is usually called steam set, or alternately twist set. After steam setting of the yarn, the tendency towards snarl formation of the yarn will be reduced, which gives better dimensional stability of yarn and ensures better performance during weaving operation. Under such processing conditions, spandex can be just temporally “set”. The “frozen” power can come back in following finishing processing.

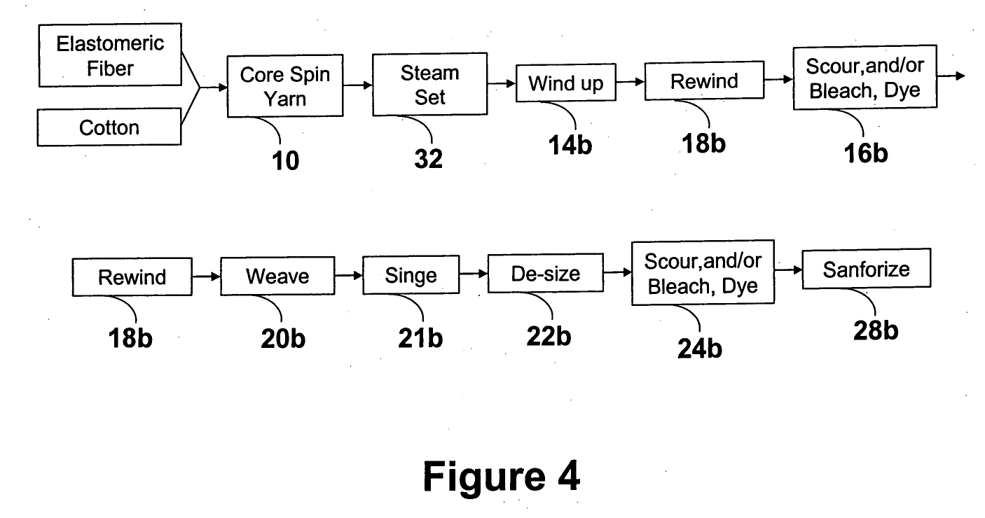

We found that when the traditional spandex composite yarns were steam pretreated in an autoclave under temperatures between about 110° C. to about 130° C., the yarn potential stretch levels reached from about 20% to about 40%. FIG. 4 is a block diagram setting out the method of the second embodiment. Like reference numerals indicate like steps in FIGS. 2, 3 and 4, however, the reference numerals include also a “b” designation in FIG. 4 to emphasize that the corespun composite yarn is steam set differently, and thereafter a corespun yarn with different properties is processed in this second embodiment.

Referring to FIG. 4, an elastomeric fiber is core spun with a hard fiber or hard yarn, denoted as cotton in FIG. 4 to form a corespun yarn 10. Different from the first embodiment of the method set out in FIG. 3, during the core-spinning step, the elastomeric yarn may be drafted at conventional draft levels, such as 3.5× to 3.8×.

The corespun yarn is then pretreated by steam-setting 32. Preferably, two cycles of steam set processing are used: first cycle steaming→vacuum→second cycle steaming. The steam temperature can be between about 110° C. to about 130° C. The steaming time may depend on the package size. For example, for cops with about 80 to about 100 grams of composite yarn, first and second cycle steaming time can be about 6 to about 8 minutes and about 16 to about 20 minutes, respectively. For 1 Kg weight bobbins, it may take 20 minutes and 60 minutes in first and second cycles, respectively. After such pretreatment steam setting, the yarn potential stretch for the steam treated composite yarn can be very similar to yarn made through the low draft method as disclosed in the first embodiment.

Following the pretreatment steam setting, the composite yarn is processed as customary in the industry. Exemplary steps are set out in FIG. 4. The composite yarn is wound up 14b, rewound 18b, scoured and/or bleached, dyed 16b, rewound 18b, and woven to form a shirting fabric. Preferably, the composite yarn forms the weft. The fabric is then treated as desired and customary in the industry, except that the fabric need not be heat set. As shown in FIG. 4, the fabric may be singed 21b, de-sized 22b, scoured and/or bleached and dyed 24b, and sanforized 28b. The fabric made from such yarns exhibits good hand, low shrinkage, and good air permeability—breathability.

By varying the steaming temperature in the pretreatment steam set (step 32 in FIG. 4), the yarn potential stretch levels can be varied. This enables a method to tailor the yarn for different fabric styles and patterns. The advantage of this new approach is low cost. In contrast to existing systems, this new method may enable 40D and 70D spandex to be used in composite yarns in additional to utilizing higher draft levels in making said yarns.

After the pretreatment steam setting step, the extra contractive power of the elastic composite yarn is diminished. In the ensuing textile processes, the yarn behaves more like rigid cotton yarn. It is easier to finish by yarn dyeing (step 16b in FIG. 4) and to weave (step 20b in FIG. 4). The fabric will have no extra shrinkage in finishing, which diminishes crease marks on the fabric surface. In addition, although a manufacturer may choose to heat set the fabric, such heat-setting is not be required. It also may provide low stretch and low growth stretch woven fabric with better cotton-like hand. For spinning processes, no special care is required.

Preferably, steam set temperature on the composite yarns should be between about 110° C. to about 130° C. For normal spandex, the steam setting temperature is about 116° C. to about 130° C., but for spandex with higher heat-setting efficiency, such as Lycra® spandex type 563, the steam-setting temperature is about 112° C. to about 116° C.

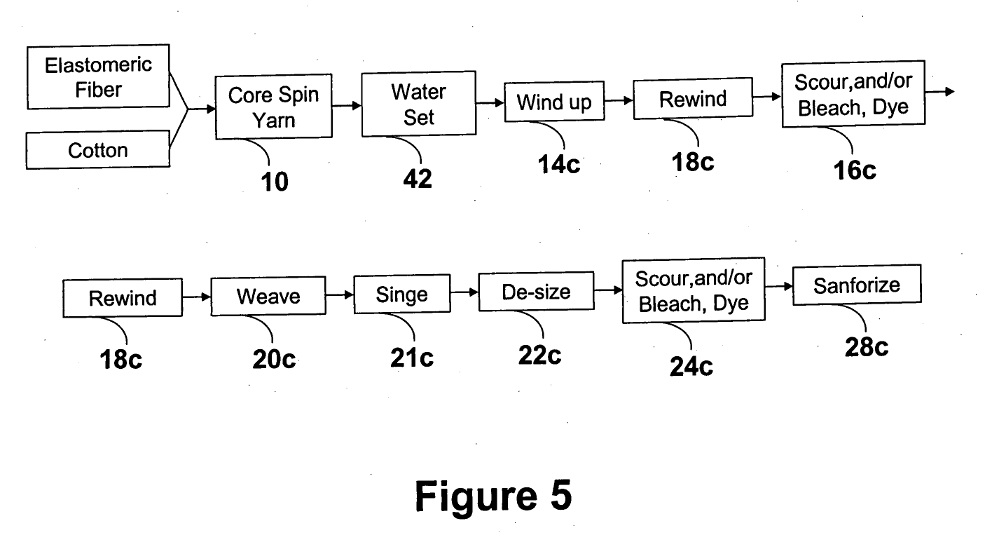

In a third embodiment of the invention, the heat-setting and yarn-twist set steps commonly used in background art shirting fabric forming methods (such as illustrated in FIG. 2) can be eliminated by pre-treating the corespun composite yarn with a hot water set prior to yarn dyeing or weaving. FIG. 5 is a block diagram setting out the method of the third embodiment. Like reference numerals indicate like steps in FIGS. 2, 3, 4 and 5, however, the reference numerals include also a “c” designation in FIG. 5 to emphasize that the corespun composite yarn is pretreated differently, and thereafter a corespun yarn with different properties is processed in this third embodiment. Referring to FIG. 5, an elastomeric fiber is core spun with a hard fiber or hard yarn, denoted as cotton in FIG. 5 to form a corespun yarn 10. Different from the first embodiment of the method set out in FIG. 3, during the core-spinning step, the elastomeric yarn may be drafted at conventional draft levels, such as 3.0× to 4.0× for 30 to 40 denier spandex.

The corespun composite yarn is then pretreated in hot water 42. Treating composite yarns in hot water is a common practice during yarn preparation and yarn dyeing processes, such as scouring, bleaching and dyeing. However, most of these conventional operations do not exceed 100° C. We unexpectedly found that treating elastic composite yarns with hot water at a temperature from about 110° C. to about 132° C. for about 5 to about 30 minutes reduces the yarn contract power to a desired level for weaving to form a stretch shirting fabric. After such hydro-setting pre-treatment step, the yarn potential stretch is from about 20% to about 40%, which is very similar to yarn made via the low draft method as disclosed in the first embodiment.

Normal package dye machinery can be used for this hydro-setting process. Pump pressure should be kept low to obtain uniform treatment. In general, a pressure-of 15 to 25 pounds per square inch is satisfactory for most composite yarns containing 40 to 70 denier spandex. The bypass valve should be adjusted to give differential pressure between inside and outside flow of 5 to 10 pounds per square inch (35 to 69 kPa). Standard two-way flow, as in conventional dyeing, will assure an even distribution of heat throughout the package. In some cases, it may use predominantly inside-to-outside flow or outside-to-inside flow.

Through changing the water temperature, the yarn potential stretch can be controlled. This creates a way to tailor the yarn to match different fabric style and patterns, which has economic advantages. The machinery used for a hot water set is common to those skilled in the art. For example, a Burlington 6# Package Dyer from Burlington Engineering Company and Gaston County Dyeing Machine Co. of North Carolina can be used.

Preferably, the water set temperature used on the composite yarn should be between about 116° C. to about 127° C. for about 5 to about 30 minutes. For elastic composite yarns made with conventional spandex of 40D to 70D denier, setting temperatures preferably are from about 121° C. to about 127° C. For elastic composite yarns made with Lycra® spandex type 563, setting temperatures preferably are from about 116° C. to about 121° C.

After the hydro setting process, the extra contractive power of spandex composite yarn can be diminished. The composite yarns usually have the appearance and characteristics of conventional yarns. In the following textile processing, the composite yarn behaves more like rigid cotton yarn.

Referring again to FIG. 5, the hydroset composite yarn is processed as customary in the industry. Exemplary steps are set out in FIG. 5. The composite yarn is wound up 14c, rewound 18c, scoured and/or bleached, dyed 16c, rewound 18c, and woven 20c to form a shirting fabric. In one example shirting fabric, the composite yarn forms the weft. The fabric is then treated as desired and customary in the industry, except that the fabric need not be heat set. As shown in FIG. 5, the fabric may be singed 21c, de-sized 22c, scoured, and/or bleached and dyed 24c, and sanforized 28c. The fabric made from such yarns exhibits good hand, low shrinkage, and good air permeability—breathability.

It can be easier to use a composite yarn of this embodiment in yarn dye finishing processes 16c and weaving 20c. Stretch is regenerated by wet relaxation of the yarn, or in the finishing operation after weaving. The fabric may not have additional shrinkage in finishing, which may reduce crease marks on the fabric surface. Fabric heat-setting is not required. It also can provide low stretch and low growth fabric with better cotton hand.

We found that the openness of the fabric structure can have significant effects on the quality parameters for stretch woven shirting fabrics. If the fabric structure on the loom is too open, the fabric can have an unstable structure and excessive stretch. If the fabric structure on the loom is too compact, the fabrics may not generate enough stretch. The openness of the fabric can be characterized as “Fabric Cover Factor”, which determines the degree of yarn occupation or cover in fabric. “Fabric Cover Factor” quantifies the number of yarns that are side-by-side as a percentage of the maximum number of the yarns that can lie side-by-side. Because of the reduced retractive power of the elastomeric yarn in this invention, a fabric with more open structure will not be tightly jammed after finishing. The more open structure gives the fabric lower weight, better air permeability, and a more cottony hand.

We found that good results can be obtained when the warp yarn cover factor on the loom is about 6% to about 10% lower than typical stretch woven shirting fabrics. For plain weave fabrics, the preferred Fabric Cover Factor can be from about 45% to about 70%, and can be typically about 55% in warp direction and from about 30% to about 50%, and can be typically about 40% in weft direction.

Analytical Methods:

Yarn Potential Stretch:

Elastic corespun yarns were formed into a skein with 50 cycles with a standard sized skein reel at a tension of about 0.1 grams per denier. The length of one cycle yarn is 1365 mm. The skein yarn was boiled off at 100° C. water for 10 minutes under free tension. The skeins were dried in air and were conditioned for 16 hours at 20° C.+/−2° C. and 65% relatively humidity, +/−2%.

The skein was folded over four times to form a thickness which is 16 times the thickness of the original skein of yarn. The folded skein was mounted on an Instron tensile testing machine. The skein was extended to a load of 1000 grams force and relaxed for three cycles. During the third cycle, the length of skein under 0.04 Kg load force is recorded as L₁, the length of skein under 1 Kg force is recorded as L₀. Yarn Potential Stretch (YPS) is calculated as follows:
Yarn Potential Stretch (YPS) %=(L₀−L₁)/L₀*100
Woven Fabric Elongation (Stretch)

Fabrics are evaluated for % elongation under a specified load (i.e., force) in the fabric stretch direction(s), which is the direction of the composite yarns (i.e., weft, warp, or weft and warp). Three samples of dimensions 60 cm×6.5 cm are cut from the fabric. The long dimension (60 cm) corresponds to the stretch direction. The samples are partially unraveled to reduce the sample widths to 5.0 cm. The samples are then conditioned for at least 16 hours at 20° C.+/−2° C. and 65% relatively humidity, +/−2%.

A first benchmark is made across the width of each sample, at 6.5 cm from a sample end. A second benchmark is made across the sample width at 50.0 cm from the first benchmark. The excess fabric from the second benchmark to the other end of the sample is used to form and stitch a loop into which a metal pin can be inserted. A notch is then cut into the loop so that weights can be attached to the metal pin.

The sample non-loop end is clamped and the fabric sample is hung vertically. A 30 Newton (N) weight (6.75 LB) is attached to the metal pin through the hanging fabric loop, so that the fabric sample is stretched by the weight. The sample is “exercised” by allowing it to be stretched by the weight for three seconds, and then manually relieving the force by lifting the weight. This cycle is carried out three times. The weight is allowed then to hang freely, thus stretching the fabric sample. The distance in millimeters between the two benchmarks is measured while the fabric is under load, and this distance is designated ML. The original distance between benchmarks (i.e., unstretched distance) is designated GL. The % fabric elongation for each individual sample is calculated as follows:
% Elongation (E %)=((ML−GL)/GL)×100.
The three elongation results are averaged for the final result.
Woven Fabric Growth (Unrecovered Stretch)

After stretching, a fabric with no growth would recover exactly to its original length before stretching. Typically, however, stretch fabrics will not fully recover and will be slightly longer after extended stretching. This slight increase in length is termed “growth.”

The above fabric elongation test should be completed before the growth test. Only the stretch direction of the fabric is tested. For two-way stretch fabric both directions are tested. Three samples, each 55.0 cm×6.0 cm, are cut from the fabric. These are different samples from those used in the elongation test. The 55.0 cm direction should correspond to the stretch direction. The samples are partially unraveled to reduce the sample widths to 5.0 cm. The samples are conditioned at temperature and humidity as in the above elongation test. Two benchmarks exactly 50 cm apart are drawn across the width of the samples.

The known elongation % (E %) from the elongation test is used to calculate a length of the samples at 80% of this known elongation. This is calculated as:
E(length) at 80%=(E %/100)×0.80×L,
where L is the original length between the benchmarks (i.e., 50.0 cm). Both ends of a sample are clamped and the sample is stretched until the length between benchmarks equals L+E (length) as calculated above. This stretch is maintained for 30 minutes, after which time the stretching force is released and the sample is allowed to hang freely and relax. After 60 minutes the % growth is measured as:
% Growth=(L₂×100)/L,
where L₂ is the increase in length between the sample benchmarks after relaxation and L is the original length between benchmarks. This % growth will be measured for each sample and the results averaged to determine the growth number.
Woven Fabric Shrinkage

Fabric shrinkage is measured after laundering. The fabric is first conditioned at temperature and humidity as in the elongation and growth tests. Two samples (60 cm×60 cm) are then cut from the fabric. The samples should be taken at least 15 cm away from the selvage. A box of four sides of 40 cm×40 cm is marked on the fabric samples.

The samples are laundered in a washing machine with the samples and a loading fabric. The total washing machine load should be 2 kg of air-dried material, and not more than half the wash should consist of test samples. The laundry is gently washed at a water temperature of 40° C. and spun. A detergent amount of 1 g/l to 3 g/l is used, depending on water hardness. The samples are laid on a flat surface until dry, and then they are conditioned for 16 hours at 20° C.+/−2° C. and 65% relative humidity +/−2% rh.

Fabric sample shrinkage is then measured in the warp and weft directions by measuring the distances between markings. The shrinkage after laundering, C %, is calculated as:
C %=((L₂−L₁)/L₁)×100,
where L₁ is the original distance between markings (40 cm) and L₂ is the distance after drying. The results are averaged for the samples and reported for both weft and warp directions. Positive shrinkage numbers reflect expansion, which is possible in some cases because of the hard yarn behavior.
Fabric Cover Factor:

Fabric Cover Factor quantifies the actual number of yarns that are side by side as a percentage of the maximum number of the yarns that can lie side by side. It is calculated as follows:

$$\text{Fabric Cover Factor \%} \frac{\text{Actual Ends/} \text{inch}}{\text{Maximum Ends/inch}} \times 100$$

The maximum ends of yarn are the number of the yarns that can lie down side-by-side in one inch of fabric in a jammed structure with no yarns overlapping. Yarn cover factor (YCF) is mainly determined by yarn diameter or count, expressed as:
Maximum Ends/inch=CCF*(Yarn Count,Ne)^{ˆ}^{0.5}

CCF refers to compact cover factor. For 100% cotton ring spun yarn, CCF was determined to be 28. Yarn count (Ne) represents the yarn size. It is equal to the number of 840 yard skeins required to weigh one pound. As yarn count values increase, the fineness of the yarn increases.

Fabric Weight

Woven fabric samples are die-punched with a 10 cm diameter die. Each cut-out woven fabric sample is weighed in grams. The “fabric weight” is then calculated as grams/square meters.

### EXAMPLES

The following examples demonstrate the present invention and its capability for use in manufacturing a variety of light weight woven fabrics. The invention is capable of other and different embodiments, and its several details are capable of modifications in various apparent respects, without departing from the scope and spirit of the present invention. Accordingly, the examples are to be regarded as illustrative in nature and not as restrictive.

For each of the following nine examples, 100% cotton ring spun yarn is used as warp yarn. The 100% cotton yarn used in the warp direction was sized before beaming. The sizing was performed in a Suziki single end sizing machine. PVA sizing agent was used. The temperature in the sizing bath was about 42° C. and the air temperature in the dry area was about 88° C. Sizing speed was about 300 yards/minute (276 meters per minute). The residence time of the yarn in the dry area was about 5 minutes.

Lycra® spandex/cotton corespun yarns were used as the weft yarn. Table 1 lists the materials and process conditions that were used to manufacture the corespun yarns for each example. Lycra® spandex is available from Invista S.à r.L., of Wilmington, Del. and Wichita, Kans. For example, in the column headed “Spandex 40d” means 40 denier spandex; T162 or T563B refers to commercially available types of Lycra®; and 3.5× means the draft of the Lycra® imposed by the core-spinning machine (machine draft). For example, in the column headed “Hard Yarn”, 40 is the linear density of the spun yarn as measured by the English Cotton Count System (or Ne). The rest of the items in Table 1 are clearly labeled.

Stretch woven fabrics were subsequently made, using the corespun yarn of each example in Table 1. The corespun yarns were used as weft yarns. Table 2 summarizes the yarns used in the fabrics, the weave pattern, and the quality characteristics of the fabrics. Some additional comments for each of the examples are given below. Unless otherwise noted, the shirting fabrics were woven on a Donier air-jet loom. Loom speed was 500 picks/minute. The widths of the fabric were about 76 and about 72 inches (about 193 and about 183 cm) in the loom and greige state, respectively.

Each greige fabric in the examples was finished by first passing it under low tension through hot water three times at 71° C., 82° C., and 94° C. to desize.

Then, each woven fabric was pre-scoured with 3.0 weight % Lubit®64 (Sybron Inc.) at 49° C. for 10 minutes. Afterwards it was de-sized with 6.0 weight % Synthazyme® (Dooley Chemicals. LLC Inc.) and 2.0 weight % Merpol® LFH (E.I. DuPont Co.) for 30 minutes at 71° C., and then scoured with 3.0 weight % Lubit® 64, 0.5 weight % Merpol® LFH and 0.5 weight % trisodium phosphate at 82° C. for 30 minutes. The fabric was then bleached with 3.0 weight % Lubit® 64, 15.0 weight % of 35% hydrogen peroxide, and 3.0 weight % sodium silicate at pH 9.5 for 60 minutes at 82° C. Fabric bleaching was followed by jet-dyeing with a black or navy direct dye at 93° C. for 30 minutes. No heat-setting was performed on these shirting fabrics.

TABLE 1

| | Spandex | | | Hard | Yarn | Yarn Set | | Yarn |
|---|---|---|---|---|---|---|---|---|
| | Dtex | Lycra ® | Sandex | Yarn | Setting | Temperature | Yarn Set | Potential |
| Example | (Denier) | Types | Draft | (Ne) | Method | (° C.) | Time (min) | Stretch (%) |
| 1C | 44 (40) | T162C | 3.5X | 40 | No | na | na | 61.1 |
| 2 | 22 (20) | T175C | 1.5X | 40 | No | na | na | 21.4 |
| 3 | 22 (20) | T563B | 1.5X | 50 | No | na | na | 31.7 |
| 4 | 22 (20) | T175C | 1.5X | 50 | No | na | na | 21.4 |
| 5 | 22 (20) | T175C | 1.5X | 50 | No | na | na | 21.4 |
| 6 | 22 (20) | T162C | 1.5X | 50 | No | na | na | 21.4 |
| 7 | 44 (40) | T563B | 3.5X | 40 | Steam | 110 | 20, 30 | 29.0 |
| 8 | 44 (40) | T162C | 3.5X | 40 | Water | 121 | 20 | 39.7 |
| 9C | 44 (40) | T563B | 3.5X | 40 | Steam | 132 | 20, 30 | 1.7 |
| 10C | 44 (40) | T563B | 3.5X | 40 | No | na | na | 60.1 |
| 11C | 40 (40) | T162C | 3.5X | 40 | Steam | 99 | 20, 30 | 54.1 |
| 12C | 40 (40) | T563B | 3.5X | 40 | Water | 99 | 20 | 55.2 |
| 13 | 40 (40) | T563B | 3.5X | 40 | Steam | 121 | 20, 30 | 10.0 |
| 14 | 40 (40) | T162C | 3.5X | 40 | Steam | 110 | 20, 30 | 43.3 |
| 15 | 40 (40) | T162C | 3.5X | 40 | Steam | 121 | 20, 30 | 37.4 |
| 16 | 40 (40) | T162C | 3.5X | 40 | Water | 132 | 20 | 22.5 |

TABLE 2

| | | | | Fabric | | | | | | | Fabric |
|---|---|---|---|---|---|---|---|---|---|---|---|
| | | Warp | | on loom | Finshed | | | | Fabric | | Cover |
| | | Yarn | | (warp | fabric | Fabric | | | Shrinkage | Air | Factor |
| | | (Ne, 100% | Weave | EPI × weft | Width | Weight | Fabric | Fabric | (Warp % × | Perm | (Warp % × Weft |
| Example | Weft Yarn | cotton) | pattern | PPI) | (cm) | (g/m²) | Stretch % | Growth % | Weft %) | (CFM) | %) |
| 1C | 40 Ne | 80/2 | plain | 96 × 70 | 120 | 194 | 64 | 4.2 | 1.3 × 7.3 | 4.19 | 54 × 40 |
| | cotton/40D | | | | | | | | | | |
| | Lycra 3.5X | | | | | | | | | | |
| | CSY | | | | | | | | | | |
| 2 | 50 Ne | 80/2 | plain | 96 × 70 | 164 | 122 | 20 | 8.2 | 1.6 × 3.6 | 22.3 | 54 × 36 |
| | cotton/20D | | | | | | | | | | |
| | Lycra 1.5X | | | | | | | | | | |
| | CSY | | | | | | | | | | |
| 3 | 50 Ne | 40 | Oxford | 96 × 70 | 138 | 131 | 29 | 8.2 | 0.6 × 4.0 | 33.7 | 54 × 35 |
| | cotton 20D | | | | | | | | | | |
| | Lycra 1.5X | | | | | | | | | | |
| | CSY | | | | | | | | | | |
| 4 | 50 Ne | 40 | 2/1 twill | 96 × 70 | 146 | 130 | 22 | 5.8 | 1.3 × 4.4 | 37.1 | 54 × 35 |
| | cotton/20D | | | | | | | | | | |
| | Lycra 1.5X | | | | | | | | | | |
| | CSY | | | | | | | | | | |
| 5 | 50 Ne | 40 | 3/1 twill | 96 × 70 | 152 | 140 | 32 | 7.6 | 2.4 × 3.0 | 49.1 | 54 × 35 |
| | cotton/20D | | | | | | | | | | |
| | Lycra 1.5X | | | | | | | | | | |
| | CSY | | | | | | | | | | |
| 6 | 50 Ne | 50 | plain | 115 × 75 | 165 | 115 | 25 | 6.8 | 0.8 × 0.5 | 59.8 | 58 × 38 |
| | cotton/20D | | | | | | | | | | |
| | Lycra 1.5X | | | | | | | | | | |
| | CSY | | | | | | | | | | |
| 7 | 40 Ne | 40 | plain | 96 × 70 | 157 | 144 | 22 | 8 | 1.7 × 3.3 | 11.6 | 54 × 40 |
| | cotton/40D | | | | | | | | | | |
| | Lycra 3.5X | | | | | | | | | | |
| | CSY Steam | | | | | | | | | | |
| | Set 110° C. | | | | | | | | | | |
| 8 | 40 Ne | 40 | plain | 96 × 70 | 152 | 148 | 33 | 10 | 1.7 × 3.2 | 10.6 | 54 × 40 |
| | cotton/40D | | | | | | | | | | |
| | Lycra 3.5X | | | | | | | | | | |
| | CSY Water | | | | | | | | | | |
| | Set 121° C. | | | | | | | | | | |
| 9C | 40 Ne | 40 | plain | 96 × 70 | 175 | 122 | 6 | 2.2 | 2.3 × 0.7 | 48.5 | 54 × 40 |
| | cotton/40D | | | | | | | | | | |
| | Lycra 3.5X | | | | | | | | | | |
| | CSY Steam | | | | | | | | | | |
| | Set 132° C. | | | | | | | | | | |

### Example 1C

### Typical Stretch Woven Shirting Fabric

This is a comparison example, not according to the invention. The warp yarn was 80/2 Ne count of ring spun yarn. The weft yarn was 40 Ne cotton with 40D Lycra® corespun yarn. Lycra® draft was 3.5× in the core-spinning. This weft yarn was a typical stretch yarn used in typical stretch woven shirting fabrics, with 61% YPS. Loom speed was 500 picks per minute at a pick level 70 Picks per inch. Table 2 summarizes the test results. The test results show that after finishing, this fabric had heavy weight (194 g/m²), excessive stretch (64%), narrow width (120 cm), high weft wash shrinkage (7.3%) and low air permeability (4.19 cfm). All these data indicate that this combination of stretch yarns and fabric construction caused high fabric weight and shrinkage. Therefore, this fabric must be heat set to reduce fabric weight, control shrinkage, and increase air permeability. Also, this fabric had a harsh and less cottony hand.

### Example 2

### Stretch Poplin Shirting

This sample had the same fabric structure as in example 1C. The only difference was the use of low power elastomeric yarn as filling yarn: 20D Lycra® under 1.5× draft according to the first embodiment of the invention. The warp yarn was 80/2 Ne ring spun cotton. The weft yarn was 50 Ne cotton/20D Lycra® corespun yarn. The weft yarn had 21% YPS. The loom speed was 500 picks/minute at 70 picks per inch. Table 2 summarizes the test results. This sample had lower weight (122 g/m²), good stretch (20%), wider width (164 cm), low weft direction wash shrinkage (3.6%), and good air permeability (22.3 cfm). No heat-setting was carried out on the fabric, yet fabric appearance and hand were improved over Example 1C.

### Example 3

### Stretch Oxford Shirting

The warp yarn was 40 Ne 100% cotton ring spun yarn. The weft yarn was 50 Ne cotton/20D Lycra® T563B corespun yarn (drafted to 1.5× which is a lower draft as per the first embodiment of the invention). This elastomeric yarn had 31.7% yarn potential stretch and inserted into fabric as weft yarn at 70 picks/inch on the loom. Oxford weaving pattern was applied. The finished fabric had a low weight (131 g/m²). Without heat-setting, the sample had 29% stretch and 4.0% wash shrinkage in the weft direction. It is an ideal fabric for making stretch woven shirting fabric.

### Example 4

### Stretch 2/1 Twill Shirting

This fabric used the same warp and weft yarn as Example 3. Also, the weaving and finishing process were the same as Example 3, but its weave pattern was 2/1 twill. Table 2 summarizes the test results. This sample had proper weight (130 g/m²), good stretch (22%), wider width (146 cm), and acceptable weft direction wash shrinkage (4.4%). No heat-setting process was used, and the fabric appearance and hand was excellent.

### Example 5

### Stretch 3/1 Twill Shirting

The warp yarn was 40 Ne ring spun cotton, and the weft yarn was 50 Ne cotton/20D Lycra® corespun yarn. The Lycra® draft in the corespun yarn was 1.5×, which is a lower draft as per the first embodiment of the invention. The loom speed was 500 picks/minute at 70 picks per inch. The test results of finished fabric are listed in Table 2. The sample further confirms that low power elastomeric yarn can produce high performance stretch shirting without requiring special care. The fabric sample had basis weight (140 g/m²), available stretch (32%), width (152 cm), and wash shrinkage in weft direction (3.0%), which are acceptable for shirting applications.

### Example 6

### Yarn Dyed Stripe shirting

The weft yarn was 50 Ne cotton corespun with 20D Lycra® spandex held at 1.5× draft, which is a lower draft as per the first embodiment of the invention. The warp yarn was 50 Ne 100% cotton ring spun yarn. Before weaving, the stretch weft yarn went through package pre-treatment, including in rewinding, scouring, bleaching and rewinding. After pre-treatment, the package still had good shape. Before weaving, the warp yarn was also dyed and color strips were formed in the fabric warp direction. After weaving, the greige fabric was finished in continuous finishing range. The finish routine was: Preparation range→Finishing Range→Sanforize. In the preparation range, the fabrics passed through singeing, desizing, scouring, mercerizing and drying process. In finishing range, the wrinkle resistant resin and softener were padded before resin curing the fabrics. In the finished fabric, the warp and weft density of the cotton yarn was 147 end/in×80 picks/in, the basis weight was 115 g/m², and the weft elongation was 25%. The fabric had very low shrinkage: 0.8% in warp and 0.5% in weft.

### Example 7

### Stretch Poplin with Twist Setting Yarn

In this example the fabric had the same warp yarn and same fabric structure as in Example 2, except 40 Ne cotton/40D Lycra® corespun was used as weft yarn and the warp yarn was 40 Ne 100% ring spun cotton. The Lycra® was drafted 3.5× during covering process. This yarn was a typical elastomeric corespun yarn. In this example, the yarn was pre-treated in an autoclave with steam as per the second embodiment of the invention (like FIG. 4) before weaving. Two cycles of steam setting were used: first cycle steaming→vacuum→second cycle. The steam temperature was about 110° C. The steaming time for both first and second cycles was 20 and 30 minutes, respectively with a 20 minutes vacuum in between. From Table 1, we can see the yarn potential stretch is 29%. During this steam set, the excess power in the yarn was diminished. This yarn potential stretch (YPS) is very similar to yarn through low draft method as disclosed in Examples 2 through 6. Table 2 lists the fabric properties. The fabric made from such yarn exhibited good cotton hand, low weft shrinkage (3.3%), good stretch (22%) and wider width (157 cm). No fabric heat-setting was necessary.

### Example 8

### Hot Water Pretreated Yarn

This example had the same warp yarn and same fabric structure as Example 7, except the pretreatment step was different. 40 Ne cotton/40D Lycra® corespun yarn was used as the weft yarn. The Lycra® was drafted 3.5× during the core-spin covering process. Before weaving, the weft yarn went through hot water treatment at about 121° C. for 20 minutes in a yarn dye machine like the method set out in FIG. 5. After hot treatment and dry, the yarn was inserted into fabric as filling yarn.

From Table 1, we can see the yarn potential stretch was 39.7%. During this hot water heat treatment, the excess power in the yarn was diminished. The yarn potential stretch in this example was also similar to yarn made through low draft method as disclosed in Examples 2 through 6, and similar to the yarn made via the steam setting pretreatment process as disclosed in Example 7.

Table 2 lists the fabric properties. The fabric made from such yarn exhibited good cotton hand, low shrinkage (3.2%), good stretch (33%) and wider width (152 cm). No fabric heat-setting was necessary.

### Example 9C

### Shirting Fabric with Minimal Stretch

This is a comparison example, not according to the invention. This sample had the same fabric structure as in example 8. The only difference was the use of elastomeric yarn as filling yarn. The weft yarn was pretreated in hot steam under 132 C. After such treatment, the weft yarn only had 1.7% YPS. The loom speed was 500 picks/minute at 70 picks per inch. Table 2 summarizes the test results. This sample had very low fabric stretch (6%), which cannot satisfy the comfort requirement desired for stretch shirting fabrics.

### Example 10C

### High Yarn Potential Stretch Yarn

This is a comparison example, not according to the invention. In this example, 44 dtex T563B Lycra® spandex yarn was corespun at a draft of 3.5× with 40 Ne 100% cotton yarn. No further treatment was done. This yarn had a YPS of 60.1%, which was unacceptably high.

### Example 11C

### Steam Pretreated Yarn at Low Temperature

This is a comparison example, not according to the invention. In this example, 44 dtex T162C Lycra® spandex yarn was corespun at a draft of 3.5× with 40 Ne 100% cotton yarn. This yarn was treated with steam at 99° C. for two cycles of 20 and 30 minutes, respectively, with 20 minute vacuum cycles in between the steam cycles. This yarn had a YPS of 54.1%, which was unacceptably high. This comparison example demonstrates that higher steam temperature is needed to change the YPS of the yarn.

### Example 12C

### Water Pretreated Yarn at Low Temperature

This is a comparison example, not according to the invention. In this example, 44 dtex T563B Lycra® spandex yarn was corespun at a draft of 3.5× with 40 Ne 100% cotton yarn. This yarn was treated with water at 99° C. for 20 minutes. This yarn had a YPS of 55.2%, which was unacceptably high. This demonstrates that higher water temperature is needed to change the YPS of the yarn.

### Example 13

### Steam Pretreated Yarn

In this example, 44 dtex T563B Lycra® spandex yarn was corespun at a draft of 3.5× with 40 Ne 100% cotton yarn. This yarn was treated with steam at 121° C. for two cycles of 20 and 30 minutes, respectively, with 20 minute vacuum cycles in between the steam cycles. This yarn had a YPS of 10.0%.

### Example 14

### Steam Pretreated Yarn

In this example, 44 dtex T162C Lycra® spandex yarn was corespun at a draft of 3.5× with 40 Ne 100% cotton yarn. This yarn was treated with steam at 110° C. for two cycles of 20 and 30 minutes, respectively, with 20 minute vacuum cycles in between the steam cycles. This yarn had a YPS of 43.3%.

### Example 15

### Steam Pretreated Yarn

In this example, 44 dtex T162C Lycra® spandex yarn was corespun at a draft of 3.5× with 40 Ne 100% cotton yarn. This yarn was treated with steam at 121° C. for two cycles of 20 and 30 minutes, respectively, with 20 minute vacuum cycles in between the steam cycles. This yarn had a YPS of 37.4%.

### Example 16

### Water Pretreated Yarn

In this example, 44 dtex T563B Lycra® spandex yarn was corespun at a draft of 3.5× with 40 Ne 100% cotton yarn. This yarn was treated with water at 132° C. for 20 minutes. This yarn had a YPS of 22.5%.

We claim:

1. A method for making a stretch shirting fabric, comprising:
(a) core-spinning an elastomeric fiber and a hard fiber to form a composite core-spun elastomeric yarn, wherein the elastomeric fiber is drafted to no more than 2.7× of its original length during core-spin covering;
(b) weaving a shirting fabric with the composite core-spun yarn in the weft direction; and
(c) further processing the fabric without heat-setting.

2. The method of claim 1, wherein the elastomeric fiber is bare spandex yarn from 11 to 44 dtex.

3. The method of claim 1, wherein the hard fiber is a hard yarn with a yarn count from 10 to 80 Ne.

4. The method of claim 3, wherein the hard yarn is cotton.

5. The method of claim 1, wherein the elastomeric fiber is a bare spandex yarn from 17 to 33 dtex, the hard fiber is a hard yarn with yarn count from 30 to 60 Ne, and the spandex yarn is drafted no more than 2.5× its original length during core-spin covering.

6. The method of claim 1, wherein further processing comprises one or more steps selected from the group consisting of: cleaning, bleaching, dyeing, drying, compacting, sanforizing, singeing, de-sizing, mercerizing, and any combination of such steps.

7. A stretch shirting fabric made by the method of claim 1.

8. The fabric of claim 7, wherein the Fabric Cover Factor is between about 45% to about 70% in warp direction and from about 30% to about 50% in weft direction.

9. The fabric of claim 7, wherein the elongation in the weft direction is from about 15% to about 45%.

10. The fabric of claim 7, having a weave pattern selected from the group consisting of: plain, 2/1 twill, 3/1 twill, oxford, poplin, dobby, sateen, and satin.

11. The fabric of claim 7, wherein the elastomeric fiber is spandex, and the fabric contains from 1% to 5% by weight, based on the total fabric weight per square meter of spandex.

12. The fabric of claim 7, wherein the fabric has a weight of 175 g/m² or less, and after washing has a shrinkage of 10% or less.

13. A garment formed from the stretch shirting fabric of claim 7.

14. A method for making a stretch shirting fabric, comprising:
(a) core-spinning an elastomeric fiber and a hard fiber to form a composite core-spun elastomeric yarn;
(b) pretreating the composite corespun elastomeric yarn with hot water or steam at a temperature of at least 110° C. before dyeing or weaving;
(c) weaving a shirting fabric with the composite core-spun yarn in the weft direction; and
(d) further processing the fabric without heat-setting.

15. The method of claim 14, wherein the pretreatment is with steam in an autoclave at a temperature of from 110° C. to 130° C. for 6 to 60 minutes.

16. The method of claim 14, wherein the pretreatment is with hot water in a yarn package dyer at a temperature of from 110° C. to 132° C. for 5 to 30 minutes.

17. The method of claim 14, wherein the elastomeric fiber is bare spandex yarn from 22 to 156 dtex and the hard fiber is a hard yarn with yarn count from 10 to 80 Ne.

18. The method of claim 14, wherein the elastomeric fiber is bare spandex yarn from 44 to 78 dtex and the hard fiber is a hard yarn with yarn count from 30 to 60 Ne.

19. The method of claim 18, wherein the hard yarn is cotton.

20. The method of claim 14, wherein further processing comprises one or more steps selected from the group consisting of: cleaning, bleaching, dyeing, drying, compacting, sanforizing, singeing, de-sizing, mercerizing, and any combination of such steps.

21. A stretch shirting fabric made by the method of claim 14.

22. The fabric of claim 21, wherein the Fabric Cover Factor is between about 45% and about 70%.

23. The fabric of claim 21, wherein the elongation in the weft direction is from about 15% to about 45%.

24. The fabric of claim 21, having a weave pattern selected from the group consisting of: plain, 2/1 twill, 3/1 twill, oxford, poplin, dobby, sateen, and satin.

25. The fabric of claim 21, wherein the elastomeric fiber is spandex, and the fabric contains from 1% to 5% by weight, based on the total fabric weight per square meter of spandex.

26. The fabric of claim 21, wherein the fabric has a weight of 175 g/m² or less, and after washing has a shrinkage of 10% or less.

27. A garment formed from the stretch shirting fabric of claim 21.
